(19) United States
(12) Patent Application Publication
(10) Pub. No.: US 2015/0315770 A1
(43) Pub. Date: Nov. 5, 2015

(54) APPARATUS AND METHOD FOR A PLUMBING VALVE

(71) Applicant: Albert Monroe Johnson, Hixson, TN (US)

(72) Inventor: Albert Monroe Johnson, Hixson, TN (US)

(21) Appl. No.: 14/699,612

(22) Filed: Apr. 29, 2015

Related U.S. Application Data
(60) Provisional application No. 61/996,162, filed on Apr. 30, 2014.

(51) Int. Cl. E03C 1/04; F16K 11/02

(52) U.S. Cl. CPC E03C 1/04; F16K 11/02

(57) ABSTRACT

A plumbing valve comprising a first cylinder having a first cylinder longitudinal axis, a plurality of second cylinders each of which has a second cylinder longitudinal axis and each of which defines a second cylinder opening, and a plurality of pipe fittings each of which is disposed in one of the plurality of second cylinder openings. The first cylinder and the plurality of second cylinders are adapted to be in fluid communication, and each of the plurality of pipe fittings is adapted to removably retain a pipe. A method for removing and installing a plumbing valve comprising providing a plumbing valve, removing a pipe from each of the plurality of pipe fittings in the plurality of second cylinder openings of the plumbing valve, and inserting a pipe into each of the plurality of pipe fittings in the plurality of second cylinder openings of the plumbing valve.

### CROSS-REFERENCES TO RELATED APPLICATIONS/PATENTS

This application relates back to and claims the benefit of priority from U.S. Provisional Application for Patent Ser. No. 61/996,162 titled “Cross Valve” and filed on Apr. 30, 2014.

### FIELD OF THE INVENTION

The present invention relates generally to plumbing valves and particularly to valves used in shower and bath tub plumbing applications.

### BACKGROUND AND DESCRIPTION OF THE PRIOR ART

It is known to use valves in a variety of plumbing applications. Conventional valves, however, suffer from one or more disadvantages. For example, the installation, removal, and replacement of conventional plumbing valves are undesirably labor-intensive. The installation, removal, and replacement of conventional plumbing valves are also undesirably time-consuming. In addition, the installation, removal, and replacement of conventional plumbing valves result in costly damage to the structure, e.g., the wall, in the vicinity of the valve. Further, conventional plumbing valves cannot be installed, removed, or replaced through a conventional plumbing fixture or “rough-in” hole. Still further, conventional plumbing valves are not adapted for use with a variety of different-sized pipes. Conventional plumbing valves also require additional fittings or sweat joints to prevent leaking.

It would be desirable, therefore, if an apparatus and method for a plumbing valve could be provided that would be installed, removed, and replaced with less labor. It would also be desirable if such an apparatus and method for a plumbing valve could be provided that would be installed, removed, and replaced in less time. It would be further desirable if such an apparatus and method for a plumbing valve could be provided that would be installed, removed, and replaced without costly damage to the structure in the vicinity of the valve. It would be still further desirable if such an apparatus and method for a plumbing valve could be provided that would be installed, removed, and replaced through a conventional plumbing fixture or “rough-in” hole. It would also be desirable if such an apparatus and method for a plumbing valve could be provided that would be adapted for use with a variety of different-sized pipes. It would be further desirable if such an apparatus and method for a plumbing valve could be provided that would not require additional fittings or sweat joints to prevent leaking.

### ADVANTAGES OF THE PREFERRED EMBODIMENTS OF THE INVENTION

Accordingly, it is an advantage of the preferred embodiments of the invention claimed herein to provide an apparatus and method for a plumbing valve that may be installed, removed, and replaced with less labor. It is also an advantage of the preferred embodiments of the invention claimed herein to provide an apparatus and method for a plumbing valve that may be installed, removed, and replaced in less time. It is another advantage of the preferred embodiments of the invention claimed herein to provide an apparatus and method for a plumbing valve that may be installed, removed, and replaced without costly damage to the structure in the vicinity of the valve. It is a further advantage of the preferred embodiments of the invention claimed herein to provide an apparatus and method for a plumbing valve that may be installed, removed, and replaced through a conventional plumbing fixture or “rough-in” hole. It is a still further advantage of the preferred embodiments of the invention claimed herein to provide an apparatus and method for a plumbing valve that is adapted for use with a variety of different-sized pipes. It is yet another advantage of the preferred embodiments of the invention claimed herein to provide an apparatus and method for a plumbing valve that does not require additional fittings or sweat joints to prevent leaking.

Additional advantages of the preferred embodiments of the invention will become apparent from an examination of the drawings and the ensuing description.

### SUMMARY OF THE INVENTION

The apparatus of the invention comprises a plumbing valve. The preferred plumbing valve comprises a first cylinder having a first cylinder longitudinal axis, a plurality of second cylinders each of which has a second cylinder longitudinal axis and each of which defines a second cylinder opening, and a plurality of pipe fittings each of which is disposed in one of the plurality of second cylinder openings. Also in the preferred plumbing valve, the first cylinder and the plurality of second cylinders are adapted to be in fluid communication, and each of the plurality of pipe fittings is adapted to removably retain a pipe.

The method of the invention comprises providing a plumbing valve. The preferred plumbing valve comprises a first cylinder having a first cylinder longitudinal axis, a plurality of second cylinders each of which has a second cylinder longitudinal axis and each of which defines a second cylinder opening, and a plurality of pipe fittings each of which is disposed in one of the plurality of second cylinder openings. Also in the preferred plumbing valve, the first cylinder and the plurality of second cylinders are adapted to be in fluid communication, and each of the plurality of pipe fittings is adapted to removably retain a pipe. The preferred method also comprises removing a pipe from each of the plurality of pipe fittings in the plurality of second cylinder openings of the plumbing valve and inserting a pipe into each of the plurality of pipe fittings in the plurality of second cylinder openings of the plumbing valve.

### BRIEF DESCRIPTION OF THE DRAWINGS

The presently preferred embodiments of the invention are illustrated in the accompanying drawings, in which like reference numerals represent like parts throughout, and in which:

FIG. 1 is a front view of the preferred plumbing valve in accordance with the present invention.

FIG. 2 is a left end view of the preferred plumbing valve illustrated in FIG. 1.

FIG. 3 is a right end view of the preferred plumbing valve illustrated in FIGS. 1-2.

FIG. 4A is a partial sectional left end view of a second cylinder of the preferred plumbing valve illustrated in FIGS. 1-3 taken along sectional line 4A-4A.

FIG. 4B is a partial sectional left end view of a second cylinder of the preferred plumbing valve illustrated in FIGS. 1-3 taken along sectional line 4B-4B shown with an exemplary pipe.

### DESCRIPTION OF THE PREFERRED EMBODIMENTS OF THE INVENTION

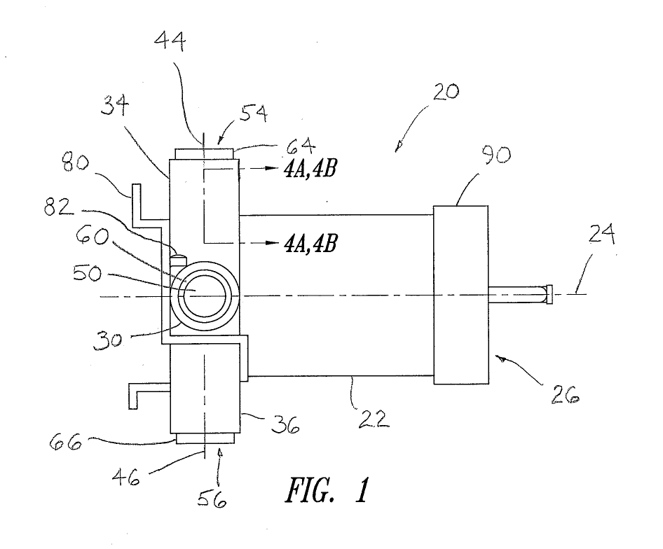

Referring now to the drawings, the preferred embodiment of the plumbing valve in accordance with the present invention is illustrated by FIGS. 1 through 4B. As shown in FIGS. 1-4B, the preferred plumbing valve is adapted to be installed, removed, and replaced with less labor, in less time, and with less expense. The preferred plumbing valve also may be installed, removed, and replaced through a conventional plumbing fixture or “rough-in” hole. The preferred plumbing valve is also adapted for use with a variety of different-sized pipes and does not require additional fittings or sweat joints to prevent leaking.

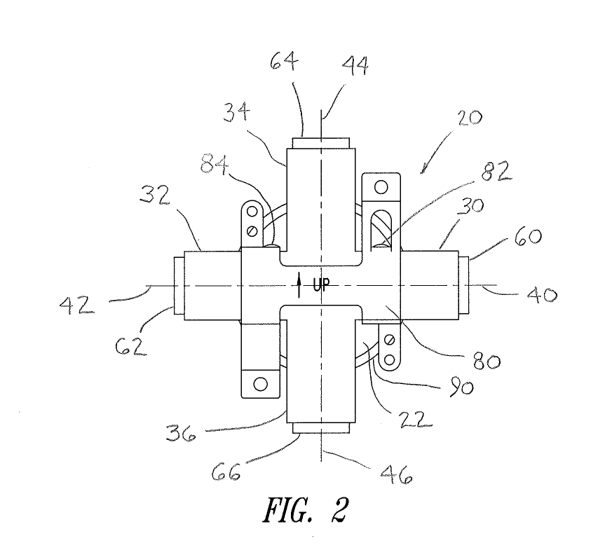

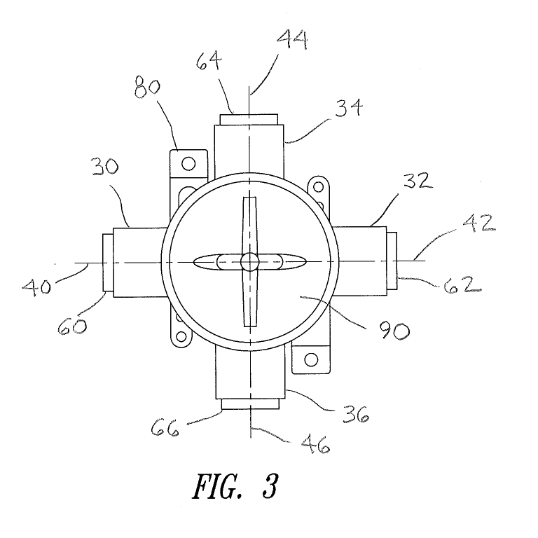

Referring now to FIG. 1, a front view of the preferred embodiment of the cross valve in accordance with the present invention is illustrated. As shown in FIG. 1, the preferred cross valve is designated generally by reference numeral 20. Preferred cross valve 20 comprises first cylinder 22 having first cylinder longitudinal axis 24 and distal end 26. Preferred first cylinder 22 is a “rough-in” valve adapted to fit into and be mounted within a conventional plumbing fixture hole. Preferred first cylinder 22 is also adapted to receive water from second cylinders 30 and 32 (see FIGS. 2 and 3) and convey water to second cylinders 34 and 36. Further, preferred first cylinder 22 is adapted to receive a thermostatic mixing valve adapted to open and close the valve in order to allow or prevent the flow of water through the pipes attached to second cylinders 30, 32, 34, and 36. The preferred thermostatic mixing valve is also adapted to control the temperature of the water flowing to the pipes connected to second cylinders 34 and 36 by changing the amounts of water received from second cylinders 30 and 32. The preferred thermostatic mixing valve is further adapted to be operably connected to a conventional shower handle which a user may move in order to control the flow and temperature of water through second cylinders 30, 32, 34, and 36. While FIG. 1 illustrates the preferred configuration and arrangement of the first cylinder, it is contemplated within the scope of the invention that the first cylinder may be of any suitable “rough-in” valve configuration and arrangement.

Referring still to FIG. 1, preferred cross valve 20 also comprises a plurality of second cylinders 30, 32, 34, and 36. Each preferred plurality of second cylinders 30, 32, 34, and 36 has second cylinder longitudinal axis 40 (see FIGS. 2 and 3), 42 (see FIGS. 2 and 3), 44, and 46, respectively. Preferably, each of preferred plurality of second cylinder longitudinal axes 40, 42, 44, and 46 is substantially perpendicular to and extends substantially radially from preferred first cylinder longitudinal axis 24. In addition, each preferred plurality of second cylinders 30, 32, 34, and 36 defines second cylinder opening 50, 52 (see FIGS. 2 and 3), 54, and 56, respectively. Preferred first cylinder 22 and preferred plurality of second cylinders 30, 32, 34, and 36 are adapted to be in fluid communication. More particularly, second cylinder 30 is adapted receive hot water from a water source, second cylinder 32 is adapted to receive cold water from a water source, second cylinder 34 is adapted to convey the hot and/or cold water it receives from second cylinders 30 and 32 to a shower head, and second cylinder 36 is adapted to convey the hot and/or cold water it receives from second cylinders 30 and 32 to a bath tub spout. While FIG. 1 illustrates the preferred configuration and arrangement of the plurality of second cylinders, it is contemplated within the scope of the invention that the second cylinders may be of any suitable configuration and arrangement. It is also contemplated within the scope of the invention that the cross valve may comprise fewer or more than four second cylinders.

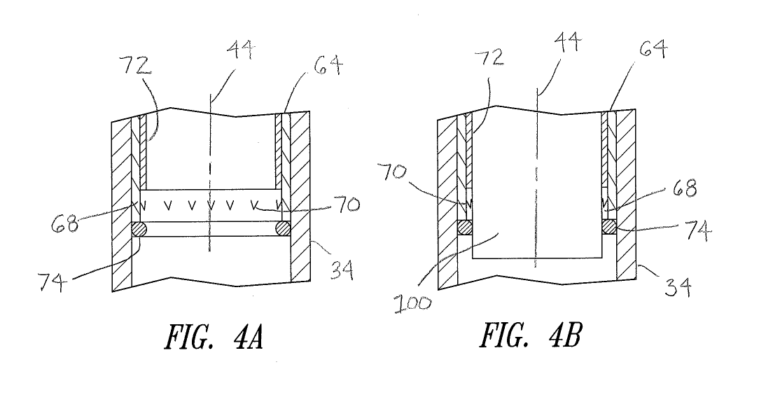

Still referring to FIG. 1, preferred cross valve 20 further comprises a plurality of pipe fittings 60, 62 (see FIGS. 2 and 3), 64, and 66. Each of preferred plurality of pipe fittings 60, 62, 64, and 66 is disposed in one of preferred plurality of second cylinder openings 50, 52, 54, and 56, respectively. Further, each of preferred plurality of pipe fittings 60, 62, 64, and 66 is adapted to removably retain a pipe. Preferably, the plurality of pipe fittings 60, 62, 64, and 66 comprises a compression or quick connect fitting such as a push-in, push-fit, push-to-connect, push-to-pull, or similar type of instant fitting. Preferred plurality of pipe fittings 60, 62, 64, and 66 are adapted to quickly connect pipes to and remove pipes from cross valve 20 without the use of tools. Each of preferred plurality of pipe fittings 60, 62, 64, and 66 comprises pipe gripping ring 68 having a plurality of teeth 70, pipe releasing sleeve 70, and O-ring 72 (see FIGS. 4A and 4B). While FIG. 1 illustrates the preferred configuration and arrangement of the pipe fittings, it is contemplated within the scope of the invention that the pipe fittings may be of any suitable configuration and arrangement.

Still referring to FIG. 1, preferred cross valve 20 still further comprises mounting bracket 80. Preferred mounting bracket 80 is removably attached to second cylinders 30 and 32 with threaded fasteners 82 and 84 (see FIG. 2), however, it is contemplated within the scope of the invention that the mounting bracket may be attached to any suitable part of cross valve 20 by any suitable means. Preferred mounting bracket 80 is adapted to permit cross valve 20 to be removably mounted to a structural support (e.g., a 2″×4″ piece of lumber) such that distal end 26 of first cylinder 22 extends through a conventional plumbing fixture hole. Preferred cross valve 20 also comprises nut 90 which is removably attached to first cylinder 22. While FIG. 1 illustrates the preferred configuration and arrangement of the mounting bracket and nut, it is contemplated within the scope of the invention that the mounting bracket and nut may be of any suitable configuration and arrangement.

Referring now to FIG. 2, a left end view of preferred cross valve 20 is illustrated. As shown in FIG. 2, preferred cross valve 20 comprises first cylinder 22, second cylinders 30, 32, 34, and 36, second cylinder longitudinal axes 40, 42, 44 and 46, pipe fittings 60, 62, 64, and 66, mounting bracket 80, threaded fasteners 82 and 84, and nut 90.

Referring now to FIG. 3, a right end view of preferred cross valve 20 is illustrated. As shown in FIG. 4, preferred cross valve 20 comprises second cylinders 30, 32, 34, and 36, second cylinder longitudinal axes 40, 42, 44 and 46, pipe fittings 60, 62, 64, and 66, mounting bracket 80, and nut 90.

Referring now to FIG. 4A, a partial sectional left end view of second cylinder 34 of preferred cross valve 20 taken along sectional line 4A-4A is illustrated. As shown in FIG. 4A, preferred cross valve 20 comprises second cylinder 34, second cylinder longitudinal axis 44, and pipe fitting 64. Preferred pipe fitting 64 comprises pipe gripping ring 68 having a plurality of teeth 70 which extend radially inwardly toward second cylinder longitudinal axis 44 and are adapted to retain a pipe in the pipe fitting. Preferred pipe fitting 64 also comprises pipe releasing sleeve 72 which is disposed inside pipe gripping ring 68 and adapted to move along second cylinder longitudinal axis 44. Further, preferred pipe releasing sleeve is adapted to slidingly engage the plurality of teeth 70 of pipe gripping ring 68 so as to move them radially outwardly from second cylinder longitudinal axis 44. Preferably, when pipe releasing sleeve 72 slidingly engages the plurality of teeth 70 of pipe gripping ring 68 so as to move the teeth radially outwardly from second cylinder longitudinal axis 44, the pipe may be removed from pipe fitting 64 without the use of any additional tools. Preferred pipe fitting 64 further comprises O-ring 74 which is adapted to produce a seal with the outer surface of the pipe inserted into the fitting.

Referring now to FIG. 4B, a partial sectional left end view of second cylinder 34 of preferred cross valve 20 taken along sectional line 4B-4B is illustrated with exemplary pipe 100 inserted into second cylinder 34 and removably retained by pipe fitting 64. As shown in FIG. 4B, preferred pipe fitting 64 comprises pipe gripping ring 68 having a plurality of teeth 70 and O-ring 74. When exemplary pipe 100 is inserted into preferred pipe fitting 64, the plurality of teeth 70 of pipe gripping ring 68 prevent the pipe from being from removed from the fitting and O-ring 74 forms a seal around the outer surface of the pipe so as to prevent leaking. When preferred pipe releasing sleeve is moved along second cylinder longitudinal axis 44 in the direction towards O-ring 74, it causes the plurality of teeth 70 of pipe gripping ring 68 to move radially outwardly from the second cylinder longitudinal axis so as to disengage from the inserted pipe. And when the preferred plurality of teeth 70 of pipe gripping ring 68 are moved radially outwardly from second cylinder longitudinal axis 44 and do not engage the inserted pipe, the pipe may be removed from fitting 64 without any tools. While FIGS. 4A and 4B illustrate the preferred configuration and arrangement of the pipe fitting, it is contemplated within the scope of the invention that the pipe fitting may be of any suitable configuration and arrangement.

The invention also comprises a method for installing and removing a plumbing valve. The preferred method comprises providing a plumbing valve such as a cross valve. The preferred plumbing valve comprises a first cylinder having a first cylinder longitudinal axis. The preferred plumbing valve also comprises a plurality of second cylinders. Each of the plurality of second cylinders has a second cylinder longitudinal axis and defines a second cylinder opening. Preferably, each of the plurality of second cylinder longitudinal axes is substantially perpendicular to and extends substantially radially from the first cylinder longitudinal axis. The preferred plumbing valve further comprises a plurality of pipe fittings such as push-in, push-fit, push-to-connect, push-to-pull, or similar type of instant fittings. Each of the plurality of pipe fittings is disposed in one of the plurality of second cylinder openings. In the preferred plumbing valve, first cylinder and the plurality of second cylinders are adapted to be in fluid communication, and each of the plurality of pipe fittings is adapted to removably retain a pipe.

The preferred method also comprises removing a pipe from each of the plurality of pipe fittings in the plurality of second cylinder openings of the plumbing valve, and inserting a pipe into each of the plurality of pipe fittings in the plurality of second cylinder openings of the plumbing valve. In the preferred method, the plumbing valve is adapted to be installed and removed through a conventional fixture hole.

In operation, several advantages of the preferred embodiments of the cross valve are achieved. For example, the preferred embodiments of the cross valve are adapted for use with any suitable conventional “rough-in” valve used in a wide variety of plumbing applications. The preferred embodiments of the cross valve are adapted to be installed, removed, and replaced through a conventional plumbing fixture or “rough-in” hole without enlarging the hole or otherwise damaging the wall behind which the valve is attached to pipes. The preferred embodiments of the cross valve eliminate the need for conventional fittings and sweat joints which require the enlargement of the conventional plumbing fixture hole. As a result, the preferred embodiments of the cross value make installation, removal, and replacement of the valve less expensive, less time-consuming, and less labor-intensive. In addition, the preferred embodiments of the cross valve are adapted for use with a variety of different-sized pipes.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

1. A plumbing valve, said plumbing valve comprising:
(a) a first cylinder, said first cylinder having a first cylinder longitudinal axis;
(b) a plurality of second cylinders, each of said plurality of second cylinders having a second cylinder longitudinal axis and each of said plurality of second cylinders defining a second cylinder opening;
(c) a plurality of pipe fittings, each of said plurality of pipe fittings being disposed in one of the plurality of second cylinder openings;
wherein the first cylinder and the plurality of second cylinders are adapted to be in fluid communication; and wherein each of the plurality of pipe fittings is adapted to removably retain a pipe.

2. The plumbing valve of claim 1 wherein the plumbing valve comprises a cross valve.

3. The plumbing valve of claim 1 wherein each of the plurality of second cylinder longitudinal axes is substantially perpendicular to the first cylinder longitudinal axis.

4. The plumbing valve of claim 1 wherein each of the plurality of second cylinder longitudinal axes extends substantially radially from the first cylinder longitudinal axis.

5. The plumbing valve of claim 1 wherein at least one of the plurality of pipe fittings is a compression fitting.

6. The plumbing valve of claim 1 wherein at least one of the plurality of pipe fittings is an instant fitting.

7. The plumbing valve of claim 1 wherein at least one of the plurality of pipe fittings is a push-fit fitting.

8. A cross valve, said cross valve comprising:
(a) a first cylinder, said first cylinder having a first cylinder longitudinal axis;
(b) a plurality of second cylinders, each of said plurality of second cylinders having a second cylinder longitudinal axis and each of said plurality of second cylinders defining a second cylinder opening;
(c) a plurality of compression fittings, each of said plurality of compression fittings being disposed in one of the plurality of second cylinder openings;
wherein the first cylinder and the plurality of second cylinders are adapted to be in fluid communication; and wherein each of the plurality of compression fittings is adapted to removably retain a pipe.

9. The cross valve of claim 8 wherein each of the plurality of second cylinder longitudinal axes is substantially perpendicular to the first cylinder longitudinal axis.

10. The cross valve of claim 8 wherein each of the plurality of second cylinder longitudinal axes extends substantially radially from the first cylinder longitudinal axis.

11. The cross valve of claim 8 wherein at least one of the plurality of compression fittings is an instant fitting.

12. The cross valve of claim 8 wherein at least one of the plurality of compression fittings is push-fit fitting.

13. A method for installing and removing a plumbing valve, said method comprising:
(a) providing a plumbing valve, said plumbing valve comprising:
(i) a first cylinder, said first cylinder having a first cylinder longitudinal axis;
(ii) a plurality of second cylinders, each of said plurality of second cylinders having a second cylinder longitudinal axis and each of said plurality of second cylinders defining a second cylinder opening;
(iii) a plurality of pipe fittings, each of said plurality of pipe fittings being disposed in one of the plurality of second cylinder openings;
wherein the first cylinder and the plurality of second cylinders are adapted to be in fluid communication; and wherein each of the plurality of pipe fittings is adapted to removably retain a pipe;
(b) removing a pipe from each of the plurality of pipe fittings in the plurality of second cylinder openings of the plumbing valve; and
(c) inserting a pipe into each of the plurality of pipe fittings in the plurality of second cylinder openings of the plumbing valve.

14. The method of claim 1 wherein the plumbing valve is a cross valve.

15. The method of claim 1 wherein each of the plurality of second cylinder longitudinal axes is substantially perpendicular to the first cylinder longitudinal axis.

16. The method of claim 1 wherein each of the plurality of second cylinder longitudinal axes extends substantially radially from the first cylinder longitudinal axis.

17. The method of claim 1 wherein at least one of the plurality of pipe fittings is a compression fitting.

18. The method of claim 1 wherein at least one of the plurality of pipe fittings is an instant fitting.

19. The method of claim 1 wherein at least one of the plurality of pipe fittings is a push-fit fitting.

20. The method of claim 1 wherein the plumbing valve is adapted to be installed and removed through a conventional fixture hole.
